(19) United States
(12) Patent Application Publication
(10) Pub. No.: US 2003/0056015 A1
(43) Pub. Date: Mar. 20, 2003

(54) Device for connecting a radio network with a wire-bound subscriber

(76) Inventors: Harry Hieb, Ulm (DE); Stefan Michelsen, Filderstadt (DE); Bruno Zurblihn, Holzheim (DE)

Correspondence Address: JANSSON, SHUPE & MUNGER, LTD, 245 MAIN STREET, RACINE, WI, 53403, US

(21) Appl. No.: 10/243,039

(22) Filed: Sep. 13, 2002

(30) Foreign Application Priority Data
Sep. 14, 2001 (EP) 01 122 103.3

(51) Int. Cl. G06F 15/16

(52) U.S. Cl. 709/249

(57) ABSTRACT

A device for connecting a radio network with at least one wire-bound subscriber with the aid of a packet switching communications network, comprising a number of radio gateways, corresponding to a number of independent calls to be made with subscribers in the radio network and which are connected to the packet switching network and which convert useful data between the signal formats of the two participating networks, whereby in each case a radio control protocol, containing the radio-specific signaling, is passed to the radio gateways from the packet switching network.

### FIELD OF THE INVENTION

The present invention refers to a device for connecting a radio network with a wire-bound subscriber.

### BACKGROUND OF THE INVENTION

Packet switching communication networks for voice transmission have become well-know, e.g. as VolP networks (VolP=Voice over Internet Protocol). A telecommunication system in which at least two different signaling protocols are used needs gateway signaling points for converting the signaling messages between the signaling protocols (WO 01/06743 A1).

In addition thereto, WO 00/54468 describes a system and a method for transferring calls between a switched network, such as the public telephone network, and a packet switching network such as the Internet. The messages conditioned in the Common Channel System No. 7 (CCS7) are received by the switched network and converted into a packet protocol using a gateway. The gateway is connected to the Internet and to other facilities via an Internet protocol network.

U.S. Pat. No. 6,198,920 describes an apparatus and a method for an end-to-end data communication, wherein incompatibilities of protocols are overcome by means of routers. Thereby, different networks, like packet switching networks and radio networks, may be connected with one another.

DE 199 58 233 A1 describes a gateway for connecting telecommunication networks in which one basic channel data converter is connected to an exchange via at least one additional basic channel data interface, and a signaling channel data converter is inserted between an existing basic/signaling channel data interface such that signaling information transferred on this data interface is filtered out for the additional basic channel data interface.

The prior art for the integration of a radio network in a switching system is the wire-bound switching technique for audio-frequency audio distribution (AF distribution). For linking the radio network to a packet switching network an analogue radio switch must be employed which must also be connected to the packet switching network for the radio control protocol. All radio control signals are interchanged via this packet switching network between the radio switch and, for example, PC workstations. The radio switch itself passes on the AF and radio control signals to the radio network.

This type of structure exhibits some disadvantages. Conducted switching for radio networks demands radial wiring and/or analogue switches which handle the distribution and level matching of the useful signals to be transmitted. Due to the continuous provision of the transmission paths and the demands on the radio control protocol, which extend beyond normal telecommunications signaling, it is not possible to use an existing telecommunication infrastructure, e.g. conventional private switching systems, for the control of a radio network.

A possible approach to a solution for avoiding an analogue radio switch and the radial wiring associated therewith is represented by the well-known convergence of conducted and packet switching networks from the field of telephony, as described above. Current protocols in this connection are H.323 and SIP for telephony control signal transmission as well as RTP/RTCP (real-time transport protocols for audio/video transmission and for transmission control). The possibilities of using transmit and receive devices (T/R devices) in radio networks in an analogue manner are however restricted by the following parameters in the telephony field:

The telephone recognizes no radio-specific signaling.

The telephone connection is always duplex. However, in radio networks also simplex or semi-duplex communication must be possible.

The telephone only creates point-to-point connections.

Call formation times are longer than 0.5 s.

A three-way conference such as frequently found in telephony is too little, even for small radio networks.

The use of MCUs (MCU=Multiport Conferencing Unit) for the realization of conferences demands increasing call formation times in proportion to the number of subscribers and causes increasing delays in the voice signal in proportion to the number of subscribers. Furthermore, the network load in the packet switched network increases proportionally to the number of subscribers, because each subscriber needs individually mixed audio data.

### SUMMARY OF THE INVENTION

The object of the invention is to provide a device for connecting a packet switching communication network with a radio network exhibiting a large number of subscribers and which is adapted in a special manner, and including switching mechanisms.

According to the invention, a device for connecting a radio network exhibiting a large number of radio subscribers with at least one wire-bound subscriber with the aid of a packet switching communication network is provided, comprising a number of radio gateways, appropriate to a large number of independent calls to be made with radio subscribers and which are connected to the packet switching communication network and which convert network channel data between the formats of the two networks participating in the connection, whereby in each case a radio control signal, containing the radio-specific signaling, is passed to the radio gateways from the packet switching network.

According to a preferred embodiment of the invention, if the device as set forth above, is operated in an analogue radio communications network, a radio gateway can be assigned to each radio channel of the radio communication network.

3. According to another preferred embodiment of the invention, a device according to claim 1 or 2, characterized in that the radio control protocols are tunneled through the useful data packets.

4. According to another preferred embodiment of the invention, a device according to claim 1 or 2, characterized in that separate data channels are provided for transmission of the radio control protocols.

5. According to another preferred embodiment of the invention, a device according to one of the previous claims for operation with a digital radio communications network, characterized in that the radio gateways are connected to a radio switch of the digital radio communications network to which address information is passed via the radio gateways.

6. According to another preferred embodiment of the invention, a device according to one of the claims 1 to 5, characterized in that the control protocol handles the distribution of the useful data through point-to-point addressing.

7. According to another preferred embodiment of the invention, a device according to one of the claims 1 to 5, characterized in that the control protocol handles the distribution of the useful data through point-to-multipoint addressing.

8. According to another preferred embodiment of the invention, a device according to claim 6 or 7, characterized in that the active speaker is determined in the simplex or semi-duplex mode through the radio control protocol and only this speaker's audio data is passed to the packet switching network for the transmission.

9. According to another preferred embodiment of the invention, a device according to one of the previous claims, characterized in that the radio control protocol contains conference set-up data.

10. According to another preferred embodiment of the invention, a device according to claim 9, characterized in that the conference set-up data contains address information of the subscribers to be invited to the conference.

11. According to another preferred embodiment of the invention, a device according to claim 9 or 10, characterized in that a summed audio signal is generated in the packet switching network from the individual audio data of the subscribers.

12. According to another preferred embodiment of the invention, a device according to claim 11, characterized in that at least one central device for forming a summed audio signal from all audio signals and devices in each end point of the packet switching network are provided which suppress the end-point specific audio signal from the summed audio signal received.

13. According to another preferred embodiment of the invention, a device according to claim 11, characterized in that devices for forming a summed audio signal from the received external audio signals are present at each end point of the packet switching network.

14. According to another preferred embodiment of the invention, a device according to claim 11, characterized in that at least one central device for forming individual summed audio signals is present in which the individual audio signal of the end point supplied with the summed audio signal is always suppressed.

15. According to another preferred embodiment of the invention, a device according to one of the previous claims, characterized in that at each end point of the packet switching network devices are provided for the active selection of the audio data of the subscribers participating in the communication and for the transfer of the selected audio data to another medium.

The device provided by the present invention is a novel type of switching device and system which is based on a packet switching network This network supports point-to-point connections (“unicast” connections) and point-to-multipoint connections (“multicast” connections) depending on choice.

In the case of Internet IP networks, for example, a point-to-multipoint addressing is possible. In the system according to the invention a commonly available protocol for the transmission of voice and telephony control signals can be employed which is adapted such that it also enables the transmission of user-defined information. This can be realized, for example, with the aid of user-to-user messages under the H.323 protocol. The radio control protocol can be tunneled through the H.323 protocol. Alternatively to this, a separate data channel can be used. All radio-specific signaling, which is combined in one radio control protocol, for example for the opening of a transmitter by pressing a PTT key (PTT=Push-To-Talk), is regarded as user-defined information.

The packet switching network is preferably an IP network. These networks are very widespread and therefore economically priced. There is the advantage of falling back on an existing infrastructure. The same applies to the preferred H.323 and SIP protocols.

Radio gateways, which act as translators between the protocols of the packet switching and radio networks, are employed as coupling elements between the packet switching network and the analogue or digital radio network.

Each end point in the packet switching network (radio gateways and, for example, PC workstations) forms a point-to-point connection during the system start with the aid of a commonly available protocol for telephony control signal transmission to the remaining end points. This opens data channels which are to be used for the individual tunneling of the radio control protocol. then an audio channel is also opened with a commonly available protocol. If the packet switching network only supports point-to-point connections, the audio channels are also formed as point-to-point connections. On the other hand, it is advantageous to make a point-to-multipoint connection for the audio channels to the remaining end points. This creates a meshed system of audio channels in which each end point is capable of receiving the audio data of another end point. This is of central significance for the realization of fundamental operating functions. However, it is also possible to transmit signaling via point-to-multipoint connections. An advantage with a point-to-multipoint connection is that, in contrast to the point-to-point connection, additional speech delay times do not occur.

This initialization process results in each end point being able to be individually supplied through the established point-to-point connections with the tunneled radio control protocol, and each end point having additional audio connections which can be realized as point-to-point or point-to-multipoint connections. The fundamental advantage compared to the telephony field is that no further dialing (of telephone numbers) is needed and therefore additional delays do not occur. After the initialization process, all radio gateways are continuously ready for operation, whereby these radio gateways are available not exclusively to one, but to all other end points for communication.

Therefore, the system initialization has the advantage that the system is almost already “awake” when access to it is required. It does not need to be first run up before forming a connection and is therefore immediately available—in contrast to telephony techniques where the subscriber is always required to wait for the formation of the connection.

In the system embodied in the invention, radio gateways couple the packet switching network with the radio network, which may be of analogue or digital implementation.

In the case of an analogue radio network, the digitized speech from the packet switching network is converted to low-frequency audio signals and passed directly from the radio gateway to an associated T/R device which operates in an individually assigned radio channel. The control signals from the radio control protocol are converted into signals which are also made available to the T/R device and which control its hardware. Each T/R device has its own radio gateway available.

In the case of a digital radio network, address information (e.g. telephone numbers in the digital network) is transmitted to the radio switch of the digital system, whereby the speech is transmitted alternatively as low-frequency signals or in coded form. In contrast to analogue radio, only one T/R device is now present which serves all radio subscribers. The individual communication channels are implemented by time division (time slots), frequency division (frequency hop) or well-known techniques of digital radio, whereby however this number of radio gateways corresponds in principle to the number of radio calls which are to be made independently. In this respect it must though be noted that multiple use of one single radio gateway is basically possible, for example in the time division mode. The invention does not exclude this possibility.

Analogue and digital radio networks largely need different signaling. A particularly flexible way of fulfilling the various requirements is represented by the tunneling of the radio control protocol through the commonly available protocol for voice and telephony control signal transmission, because here all mechanisms for forming the connection are already implemented in the packet switching network. The radio control protocol itself can, for example, be transmitted as plain text in the ASCII format whereby coding and, where necessary, compression of the communication data can also occur.

The point-to-point connections which are usual in the field of telephony also exit, for example, between a PC workstation and a radio gateway. This is a radio channel with analogue radio and a directly addressed radio subscriber with digital radio. However, different variants of the voice device arise: simplex mode, semi-duplex mode and duplex mode.

In operation of the invention, the relevant operating mode is set with the aid of the radio control protocol, for example, from a PC workstation. The audio data of the PC workstation and of the radio gateway, respectively, is transmitted via the above-mentioned point-to-point or point-to-multipoint connection depending on the packet switching network. In the case of a point-to-multipoint connection, only the end points participating in the communication, i.e. the PC workstation and the addressed radio gateway, process this audio data and transmit it to the other medium, e.g. a loudspeaker. The speech direction in the simplex and semi-duplex mode is always set through the appropriate signaling with the aid of the radio control protocol.

The device of the invention is, as a switching system, though also capable of taking part in the formation of radio-radio connections. These can be, for example, set up through a PC workstation. Here again, point-to-point communication relationship are involved.

One particular advantage of the invention is that the device of the invention fulfils switching tasks without it needing its own specific switching hardware for this, because the formation of the connection is carried out directly through the addressing of the communication packets at the transmitting subscriber. A decentralized system is involved, whereby no failure of a central component can occur. This type of architecture is of particular advantage in small packet switching networks comprising just a few end points, because little overall signaling effort is needed. Alternatively to this, a central architecture can be selected whereby dedicated switching hardware is provided for the switching tasks. This may be practicable with large networks, because otherwise the signaling effort would increase substantially due to the large number of subscribers.

A communication relationship unknown in this form in the usual field of telephony is a conference configuration within the packet switching communication network, in which more than three end points participate and which can possess the three above-mentioned speech directions, simplex, semi-duplex and duplex. With a packet switching network which only supports point-to-point connections each end-point must transmit its audio data sequentially to all other end points. This corresponds to the method described in WO 01/4153 A. However, in this case, this is not applied at packet switching communication networks. The situation is different with a packet switching network with point-to-multipoint support. Due to the point-to-multipoint connections of each individual end point to the other end points, all the audio data of the other end points is available to each end point participating in a conference.

If the simplex or semi-duplex mode is existent, the active speaker is determined via the radio control protocol (one end point takes over the decision-making function, e.g. first conference participant). Only that audio data originating from the active talker is transmitted via the packet switching network. In the duplex mode each end point participating in the communication can release audio data at the same time, and consequently each end point generates a summed audio signal from the individual received audio data of the other conference participants and transfers this, where required, to another medium, e.g. a loudspeaker. The expense required for this is very much lower than with the setting up of a conference configuration in the usual field of telephony.

In this respect it can be ensured that during the formation of the sum of the received audio signals, the end point's own audio signal is not included in the summed signal. A number of alternatives can be considered for this: a) The formation of the sum is carried out at each end point. Then the end point's own audio signal is not included in the formation of the sum. The advantage of this procedure is low network loading. b) The formation of the sum is made centrally so that all end points receive the same summed signals. Then each end point subtracts its own audio signal from the summed signal, whereby, of course, the time delays must be taken into account. The advantage of this procedure is a low loading on the control station, and c) A number of individual summed signals are formed centrally and transmitted to the individual end points, whereby however the audio signal originating from the relevant end point is missing in the individual summed signal which is transmitted to this end point. This procedure requires the most effort. It also results in a high network loading.

A similar situation arises with the so-called “monitoring” of an external connection (PC workstation to the radio subscriber, radio-radio connection, conference configuration) within the packet switching communication network, whereby the advantages of point-to-multipoint connections become particularly clear here. Due to the point-to-multipoint connections all audio data is available to each end point. Through active selection of the audio data from the end points participating in the communication and transmission of this data to another medium, for example, to the PC loudspeaker, the communication traffic can be monitored on a PC workstation. To do this, each end point only needs to be informed about each existing connection via the radio control protocol so that the appropriate selection of the audio data is possible. In the simplex or semi-duplex mode, only the audio data of the active talker must be rendered audible. In the duplex mode, each end point generates a summed audio signal from the individual audio data from the other end points to be monitored and transfers this, for example, to the PC loudspeaker.

If the packet switching network only supports point-to-point connections, then this requires the sending of a monitoring command to the appropriate radio gateway (monitoring specific to the radio channel) or to, for example, the appropriate PC workstation (monitoring specific to the workstation) via the radio control protocol. In the first case this causes the radio gateway to transmit its audio data sequentially both to the communications partner as well as to the monitoring end point. Furthermore, the radio gateway instructs on one hand the communications part via the radio control protocol to also transmit its audio data to the monitoring end point and on the other hand instructs the monitoring end point to receive this audio data. In the second case (workstation related monitoring) the roles of the radio gateway and the PC workstation are interchanged. The monitoring end point can follow the complete audio traffic of the “tapped off” PC workstation, irrespective of with whom this takes place.

This invention is explained in more detail in the following with reference to the drawings. The following are shown:

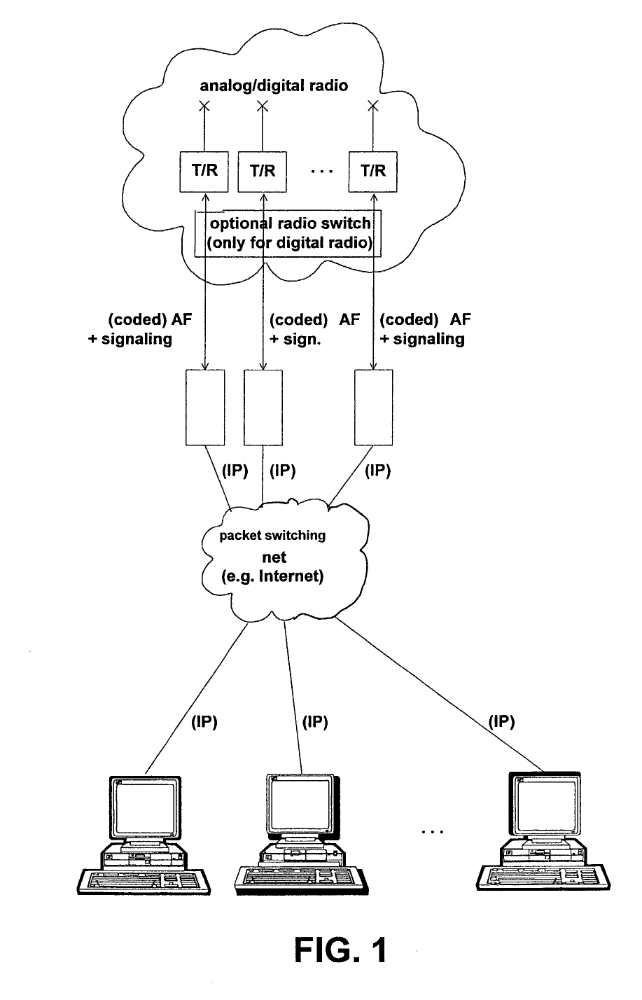

FIG. 1 shows a schematic illustration of a device embodied in the invention for the connection of a network exhibiting a larger number of subscribers with a packet switching network, and

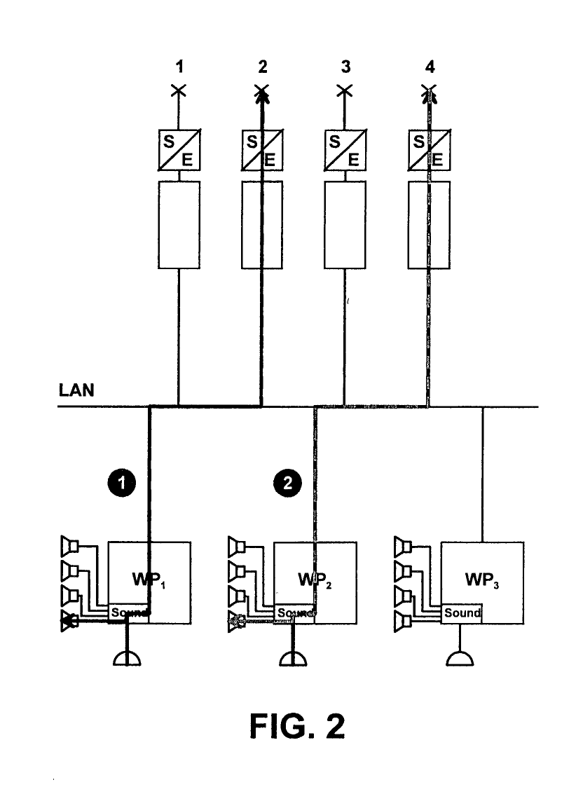

FIGS. 2 to 16 show schematically examples of signal paths in various operating cases for a device of the invention.

FIG. 1 illustrates schematically a packet switching network to which three PCs are connection as workstations. The transmission of the information to and from the PCs occurs at the lowest level as packets, for example, using the Internet Protocol. Higher protocols, such as H.323, SIP or RTP, are placed on top, whereby the radio-specific signaling is tunneled.

From the packet switching network the Internet packets pass to radio gateways where a conversion into radio-specific signals is made, for example, in LF coded LF where required, and signaling. In the analogue network each radio gateway is connected with an associated radio transmit/receive device (T/R device) which operates in one individually assigned frequency channel. The LF and signaling pass to the individual T/R devices from where the connections to external, in particular mobile radio stations, are made. If the radio network is a digital network, the radio gateways are connected with a radio switch to which a T/R device is connected that is common to all speech channels. The radio switch then provides the management of the T/R device in a well-known manner.

Correspondingly, the path in the reverse direction is from the radio T/R devices via the radio gateways into the packet switching network and from there to the workstations, whereby the signal conversion in the radio gateways is made in the reverse direction.

With reference to FIGS. 2 to 16 the following explains various operating functions which can be carried out with the invention, based on various connections. Before the individual examples are explained, the various types of communication are again highlighted.

A differentiation must always be made between point-to-point and point-to-multipoint connections, whereby the radio control protocol and also the communications data (e.g. audio data, but also other useful data) can be transmitted over both types of connection. In the following it is assumed that the radio control protocol is always transmitted via point-to-point connections. For the communications data (in the following only audio data is mentioned for the sake of simplicity) both types of connection are considered.

FIG. 2 illustrates the simplest form of all the communication methods. This is communication between one workstation WP (WP=Work Position) and a mobile radio device. A prerequisite for this are the described point-to-point connections which are set up directly during the system start between all the system components and which are maintained during operation. The software on the workstation handles the overall management.

FIG. 2 shows point-to-point addressing with which the IP packets are only transmitted to one remote radio station (packet switching network without point-to-multipoint support). Strictly speaking, only this form of addressing realized a point-to-point connection. As already mentioned, such connections already exist to all subscribers, but no LF transmission occurs via the LAN (LAN=Local Area Network), provided no workstation WP and no mobile radio subscriber presses the PTT key. The LF transmission only takes place when a radio channel is occupied by a workstation WP and PTT is then signaled. In FIG. 2 it is depicted that the first workstation WP₁ addresses the radio channel #2, whereas the second workstation WP₂ addresses the radio channel #4.

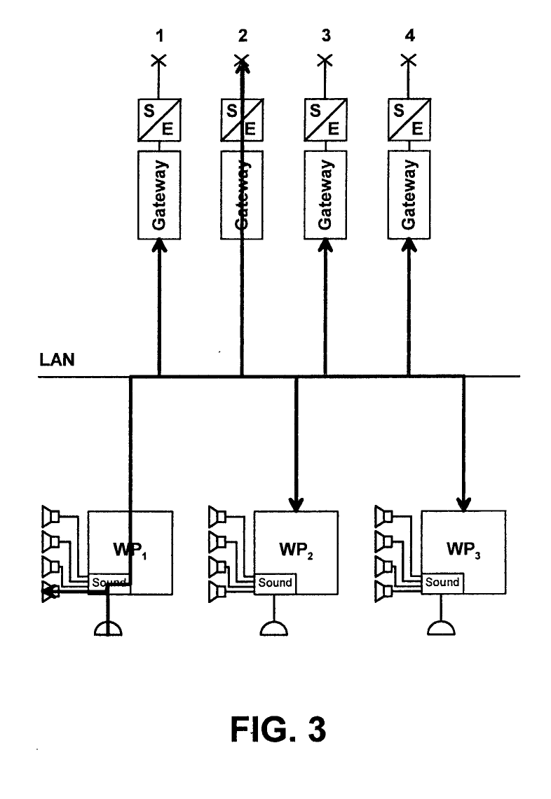

FIG. 3 shows a WP radio connection with point-to-multipoint addressing. In contrast to point-to-point addressing, the IP packets are transmitted from one workstation, for example WP₁, to a number of receivers. Here, the individual packet is put on the LAN only once. A certain address range is defined for this, whereby the receiver must allow the reception of point-to-multipoint IP packets of a certain destination address. In this way it is possible to make the IP packets available simultaneously to all components, i.e. to all radio stations and all workstations. The network loading corresponds to that of a single point-to-point connection, although a number of receivers can receive the audio communication. In FIG. 3 two point-to-multipoint audio communication streams are depicted and, more specifically, one originating from workstation WP₁ and one from radio channel #2 which are passed to all other end points, but only WP₁ receives and processes the communication stream from radio channel #2 and vice versa.

Different circuit variations can be chosen for realizing a workstation/radio-wire communication.

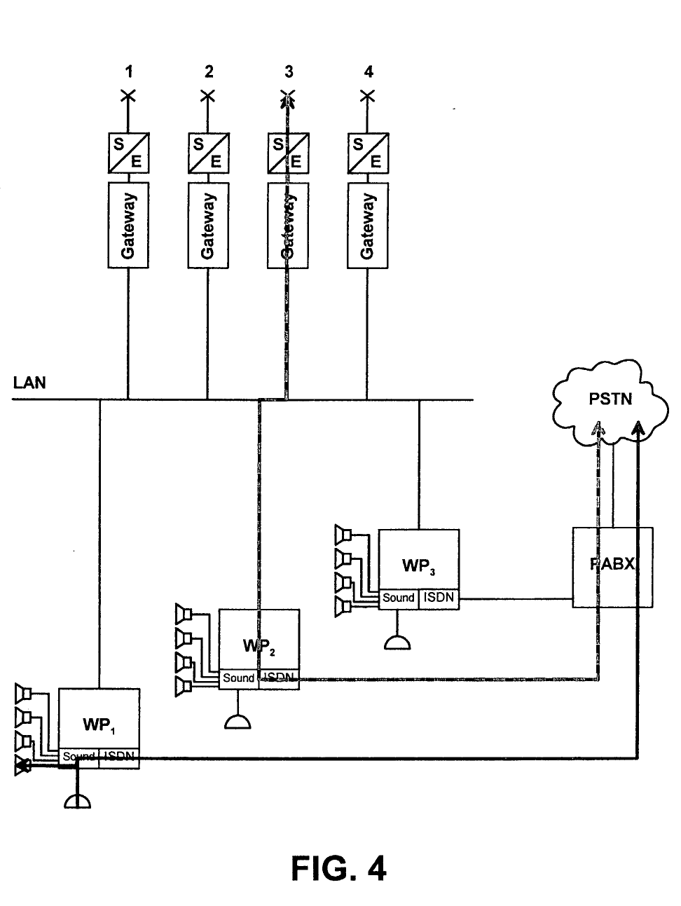

FIG. 4 clearly shows that each workstation can be equipped with an ISDN card and can be connected to the public telephone network PSTN via a private exchange station PABX. In the example illustrated, two momentarily set-up connections from the public telephone network to the workstation WP₁ and via WP₂ to the radio channel #3 are shown. Here, the WP software handles the management. The connection to the remote radio devices can then be made from the workstations—here WP₂.

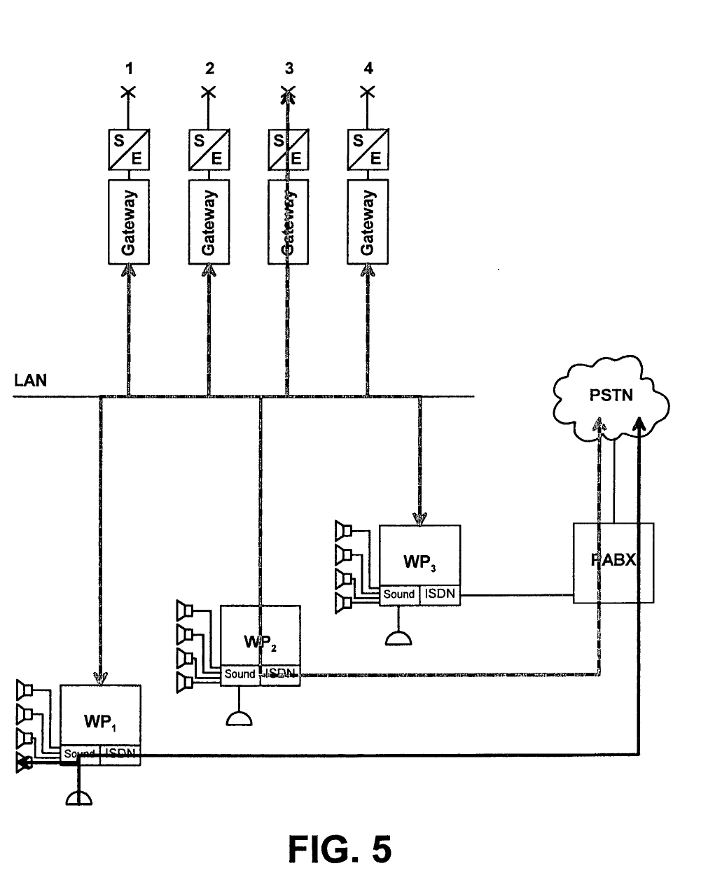

According to FIG. 4, the LF signal passed to the workstation via the wire-bound network is converted there into an IP protocol and a point-to-point connection, already existing due to the system initialization, is activated and the LF passed to a selected radio channel. The formation of the connection then occurs in the manner already described. FIG. 4 shows this type of connection from the public network via workstation WP₂ to radio channel #3.

Whereas FIG. 4 shows point-to-point addressing, FIG. 5 illustrates point-to-multipoint addressing. The messages interchanged between the public network and the workstation WP₂ are intended for radio channel #3 and are passed to it; however the other radio channels and other workstations are also ready to receive these message without being able to participate in the message interchange, because they are not required to do so. WP₁ and WP₃, as also the radio channels ## 1, 2 and 4, do not take part in the audio distribution.

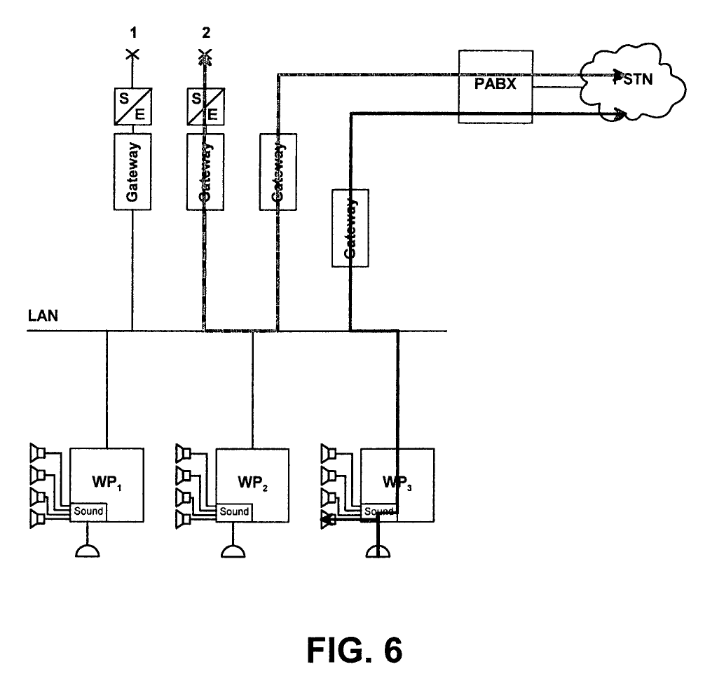

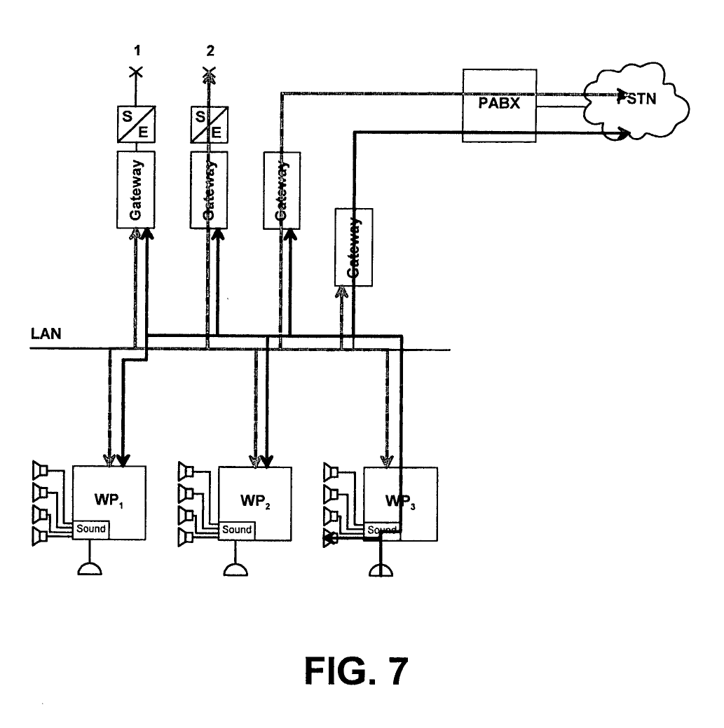

FIGS. 6 and 7 show the second variant of the PSTN circuit (unicast/multicast addressing). The private exchange station PABX is directly connected to at least one radio gateway with LF and control signals. The presence of a call from the PSTN is signaled to the workstations through the radio control protocol. The call can then be accepted by the workstation. If a radio-wire communication is to be made, then this must be initiated by a workstation. This case corresponds to a radio-to-radio connection and is dealt with in the following.

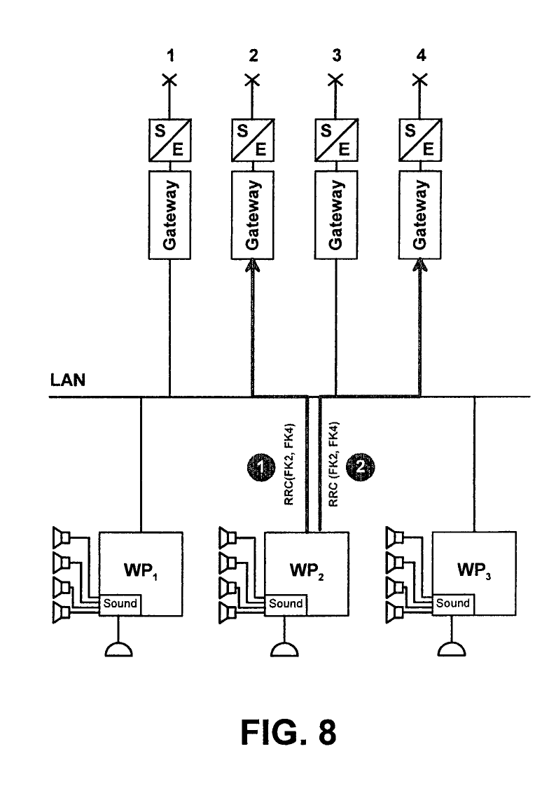

FIG. 8 shows the signaling of a radio-to-radio connection. This type of connection is always initiated by a WP, by WP₂ here. It transmits instructions to the two radio gateways for the T/R devices which are assigned to the radio channels #2 and #4. The radio gateways are thereby prompted to transmit audio data streams to the radio channel and to receive from it. As shown in FIG. 8, the workstation WP₂ transmits the request for radio-to-radio communication to the radio gateway of radio channel #2 and then to the radio gateway of radio channel #4. During the distribution of the audio communications, as in the previously explained case, a differentiation must be made between point-to-point and point-to-multipoint addressing.

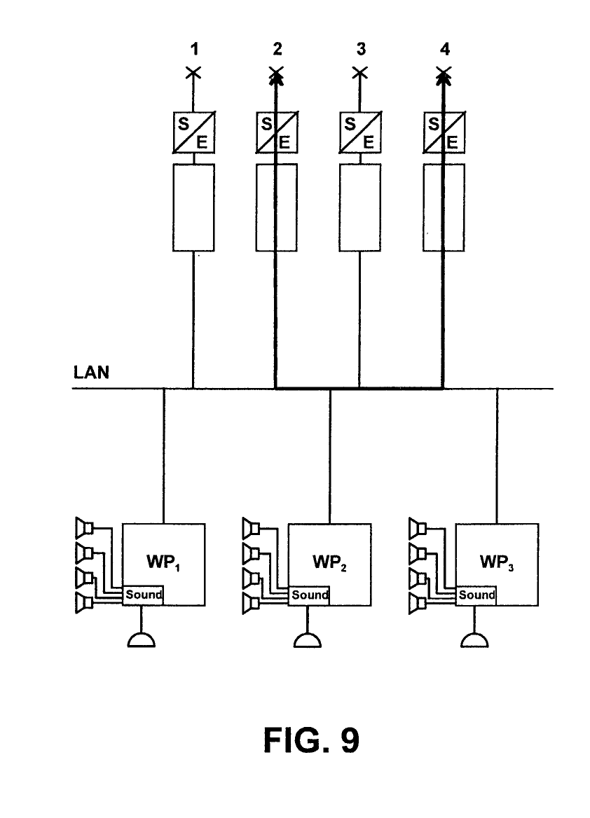

FIG. 9 shows the audio distribution with point-to-point addressing after initiation of the radio-to-radio connection. In this case a point-to-point connection takes place exclusively between two radio channels, here #2 and #4, on which, due to the packets within the packet switching network, the latter, but not one of the workstations WP, participates in the data transmission.

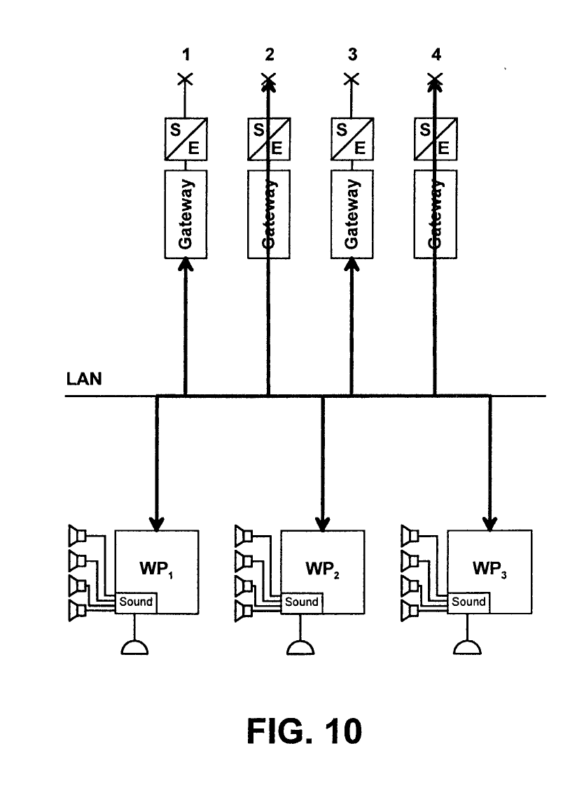

With point-to-point addressing, which is shown in FIG. 10, the other radio gateways and the workstations are prepared for the reception of the communications interchanged between radio channels #2 and #4. The termination of this type of radio-to-radio connection can take place through any workstation, because all workstations are informed about the radio-to-radio connection through the radio control protocol.

A special feature with the device embodied in the invention which has already been mentioned is the possibility of monitoring. This means that each workstation WP has at least one monitoring loudspeaker available on which the audio signals of the radio channel and of the workstation which occupy the radio channel are reproduced. The WP software here handles the management, where necessary also determining on which of the many monitoring loudspeakers the acoustic output is to occur.

Also here again, differentiation must be made between point-to-point and point-to-multipoint addressing.

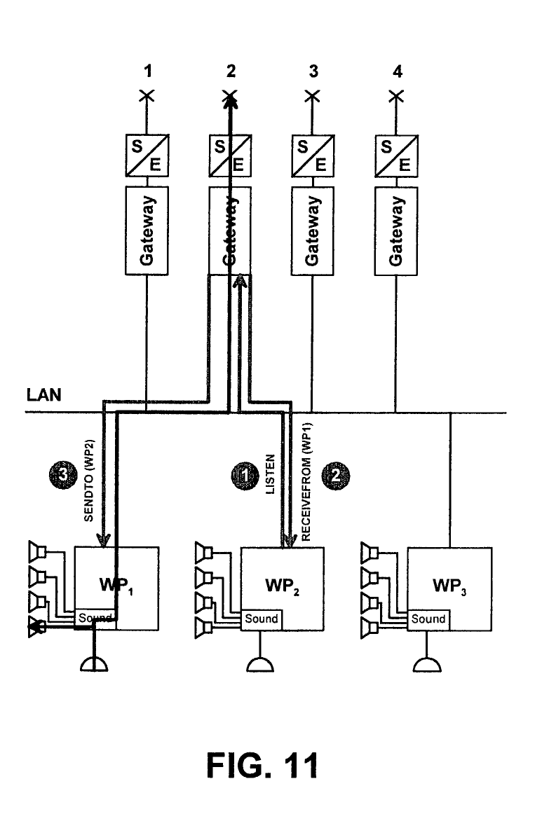

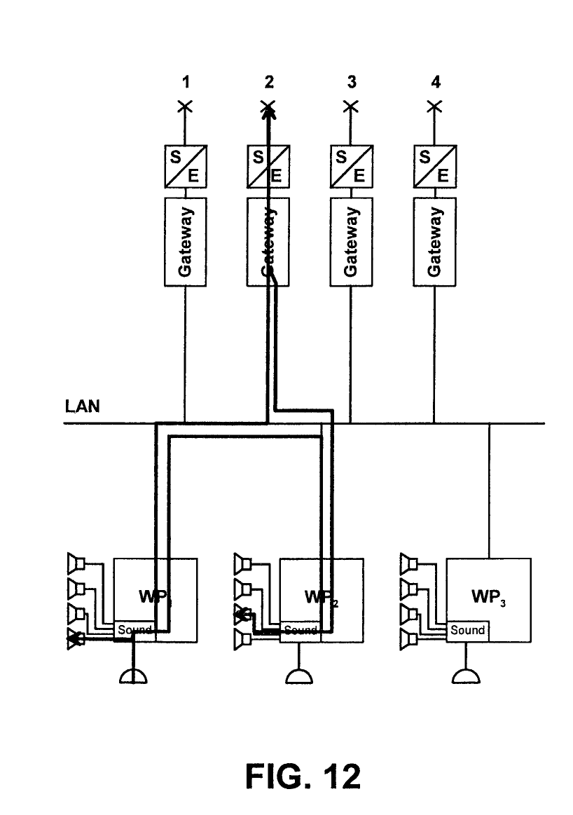

The realization of the radio-channel related monitoring shown in FIGS. 11 and 12 (corresponding to workstation-related monitoring) for point-to-point addressing largely corresponds to the audio distribution mechanism of an MCU, i.e. the audio streams are distributed sequentially.

At the start, due to the automatic system initialization during the system start, point-to-point connections always exist, as described above, between the individual components, i.e. the radio gateways and the workstations WP. A workstation WP can then occupy a radio channel for talking and thereby activate one of these already existing point-to-point connections. For example, in FIG. 11, an activated point-to-point connection is set up between the workstation WP₁ and the radio channel #2. The monitoring request of a WP is transmitted to the appropriate IP address of the radio gateway in the form of a certain command. In FIG. 11 the workstation WP₂ requests the monitoring of the radio channel #2. Through the received command, the relevant radio gateway is prompted to transmit the audio stream between radio channel #2 and WP₁ also to the monitoring WP. Furthermore, the radio gateway causes workstation WP₁ to transmit its audio data also to WP₂ and causes WP₂ to receive same.

The final setting up of this monitoring possibility is illustrated in FIG. 12. Here, it can be seen that, on the workstation WP₂, the received information from radio channel #2 and WP₁ is switched through to a loudspeaker at workstation WP₂.

As an alternative to the above described procedure, the audio distribution can also be carried out as follows. For a practical case, it is first assumed that for the formation of the connection WP₁ talks on the radio channel by pressing the PTT key. This causes an audio stream to be transmitted from WP₁ to the radio gateway of radio channel #2. The radio gateway now distributes this audio stream first to the appropriate radio channel and only then to WP₂. If a mobile radio subscriber talks on radio channel #2, then the audio stream from the radio gateway is also sequentially distributed, first to WP₁ and then to WP₂.

If the radio channel is not occupied by any WP, then the monitoring WP transfers only the audio stream of the corresponding radio channel to its own monitoring loudspeaker.

If a WP occupies a radio channel which is being monitored by other WPs, then the radio gateway transmits a signal indicating the WP expressing the monitoring request to the other monitoring WPs.

Both techniques lead to a certain speech delay, which is why there are numerical limits placed on the monitoring possibilities.

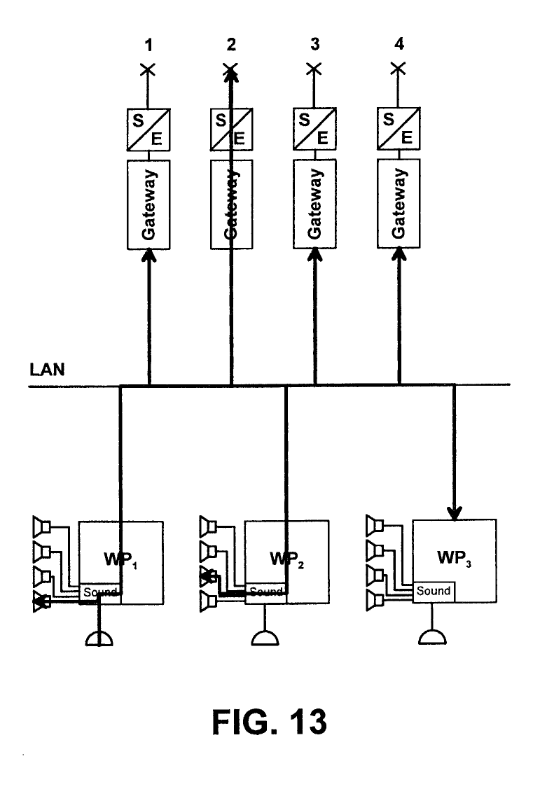

In the following the point-to-multipoint audio distribution through WPs and radio gateways is explained based on FIG. 13. The basic system status (initialization and occupation) has been established in the manner already described. However, the audio stream of a component in this embodiment is transmitted to a point-to-multipoint address, so that this is made available to all system components simultaneously.

A workstation WP which wants to monitor a radio channel, only needs in this scenario to select the appropriate audio stream and output it to a loudspeaker. For example, if a WP talks on the radio channel requested for monitoring, then the monitoring WP is informed of this via the radio control protocol. Consequently, it selects the appropriate audio stream.

If the radio channel is not occupied by any WP, then the monitoring WP transfers only the audio stream of the corresponding radio channel to its own monitoring loudspeaker.

The monitoring of an external radio channel which is being used for talking by a WP produces an echo effect if a number of WPs are installed at an audible distance next to one another. The reason for this is the delayed output of the audio signal on the monitoring WPs in relation to the undelayed output at the talking WP. With point-to-point addressing this effect is intensified due to the sequential audio distribution. In order to avoid irritating the personnel, the volume on the talking WP and the adjacent WPs should be turned down and turned down further the closer the WPs are to one another.

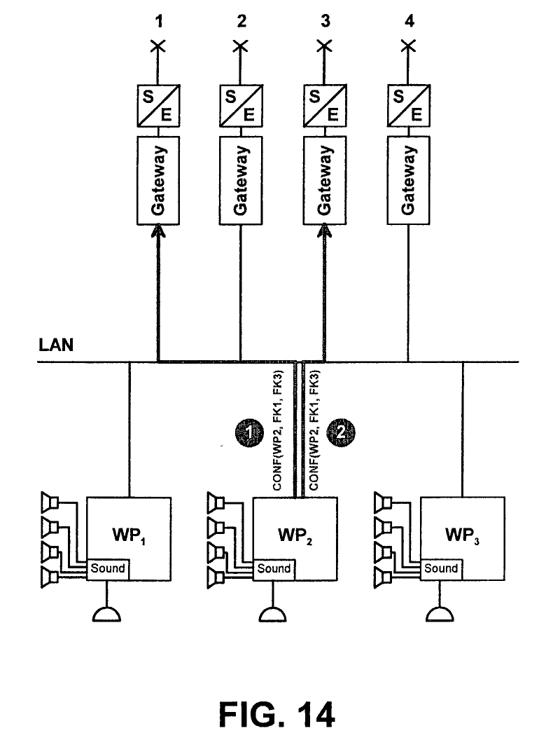

FIG. 14 shows the set-up of conference communications without an MCU. In the following a conference is taken to mean the simplex, semi-duplex or duplex communication between at least three participants (WPs, radio gateways and their connected radio subscribers). Simplex communications or alternate speaking always means that only one subscriber can speak. The one who first presses his PTT key has the prerogative. In a duplex communication, all participant shave equal rights. In this case, pressing of the PTT key merely causes transmitting of audio data. A conference can be initiated on a WP either through the consecutive selection of individual radio channels or by pressing a special button assigned to a predefined conference. The signaling sequence is however the same for both methods. Two realizations are presented in the following.

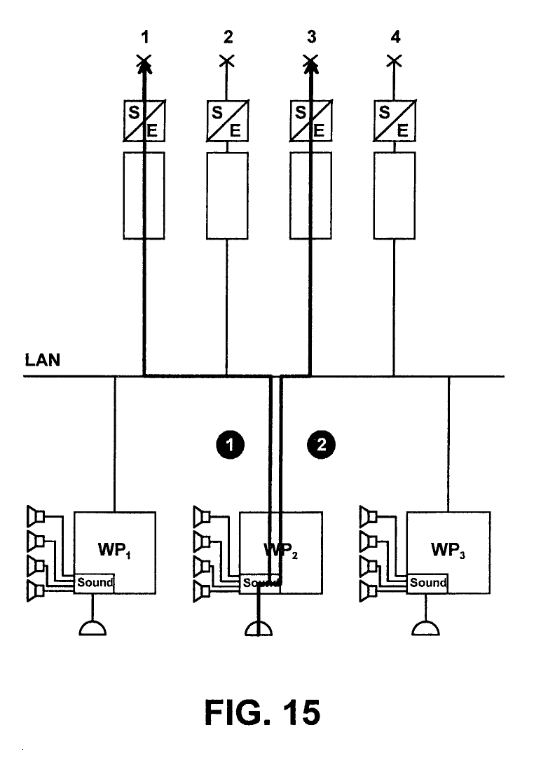

In the following, the special situation of a simplex conference communication is explained. According to FIG. 14, point-to-point connections between the individual components (radio gateways and WPs) exist at the start due to the automatic initialization of the system during the system start. A conference is initiated by a WP using a special command which is sequentially transmitted to all conference participants. The conference participants are transferred as parameters in the command. Through this, the individual components are prompted to accept audio streams from all conference participants and to distribute their own audio stream to all other conference participants sequentially. According to FIG. 14, the workstation WP₂ initiates a conference with the radio channels #1 and #3. The sequential audio distribution in the case of point-to-point addressing is illustrated in the following FIG. 15.

Three audio streams are activated, that is from WP₂ to radio channel #1, from WP₂ to radio channel #3 and from radio channel #1 to radio channel #3. According to FIG. 15, WP₂ has the prerogative for talking through pressing PTT and it transmits its audio stream sequentially to the radio channels #1 and #3.

If a further conference participant is to be included, then the command setting up the conference is extended to include the new participant and is transmitted from WP₂ to all other participants. The radio gateways check the command for changes against the actual status and then update the audio distribution.

If on the other hand, a conference participant is to exit the conference, then, analogous to the above, an appropriate command is transmitted and from that all other conference participants are informed of the change, so that they can update their audio distribution accordingly.

A conference is broken up in that an appropriate command without individual parameters is transmitted to all conference participants.

If it is to be possible that a non-participating WP enters an already existing conference, then it must be informed about conferences which already exist. This can be realized in that the command forming the conference is always transmitted to all components to inform them, even if they are not to participate in the conference individually.

It goes without saying that in the device of the invention known measures can also be applied, for example, the encryption of data and communications, transmission of ringing signals as single-tone sequences, as multi-tone sequences, in the form of coded commands, etc.

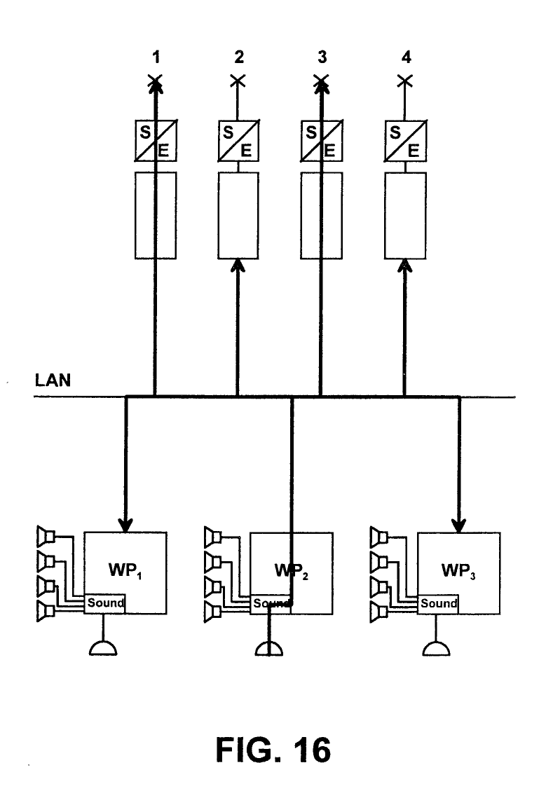

Finally, FIG. 16 shows the audio distribution with point-to-multipoint addressing. Analogous to FIG. 15 WP₂ has the talking prerogative on pressing the PTT key. However, WP₂ transmits its audio stream only once to multicast address and accordingly only the conference participants pass the audio data on. Therefore, no additional speech delays occur as in the case of point-to-point addressing and the associated sequential audio distribution.

1. A device for connecting a radio network exhibiting a large number of radio subscribers with at least one wire-bound subscriber with the aid of a packet switching communications network, comprising a number of radio gateways, corresponding to a large number of independent calls to be made with radio subscribers and which are connected to the packet switching communications network and which convert network channel data between signal formats of the two networks participating in the connection, whereby in each case a radio control protocol, containing radio-specific signaling, is passed to the radio gateways from the packet switching communications network.

2. Device according to claim 1 for operation with an analogue radio communications network where the radio communications network exhibits a number of radio channels to each of which a radio gateway is assigned.

3. A device according to claim 1 or 2 with which radio control protocols are tunneled through useful data packets.

4. A device according to claim 1 or 2 with which separate data channels are provided for the transmission of the radio control protocols.

5. A device according to claim 1 for operation with a digital radio communications network, whereby the radio gateways are connected to a radio switch of the digital radio communications network to which address information is passed via the radio gateways.

6. A device according to claim 1 in which the radio control protocol handles distribution of useful data through point-to-point addressing.

7. A device according to claim 1 in which the control protocol handles a distribution of useful data through point-to-multipoint addressing.

8. A device according to claim 6 or 7 in which an active speaker generating audio data is determined in a simplex or semi-duplex mode through the radio control protocol and only this speaker's audio data is passed to the packet switching network for transmission.

9. A device according to claim 1 in which the radio control protocol contains conference set-up data.

10. A device according to claim 9 in which the conference set-up data contains address information of subscribers to be invited to a conference.

11. A device according to claim 9 in which a summed audio signal is generated in the packet switching network from audio signals of a number of subscribers.

12. A device according to claim 11 in which at least one central device for forming a summed audio signal from all audio signals is provided and devices are provided at each subscriber in the packet switching network which receive the summed audio signal and which suppress the audio signal originating from a relevant participant.

13. A device according to claim 11 in which devices for forming a summed audio signal from the received audio signals, which originate exclusively from other subscribers, are present at each subscriber of the packet switching network.

14. A device according to claim 11 in which at least one central device for forming individual summed audio signals is present in which an individual audio signal of the subscriber supplied with the summed audio signal is always suppressed.

15. A device according to claim 1 in which at each subscriber in the packet switching communications network devices are provided for an active selection of audio data of the subscribers participating in the communication and for an transfer of the selected audio data to another medium.
